(19) United States
(12) Patent Application Publication
(10) Pub. No.: US 2010/0281463 A1
(43) Pub. Date: Nov. 4, 2010

(54) XML based scripting framework, and methods of providing automated interactions with remote systems

(76) Inventor: Brett D. Estrade, Saint Gabriel, LA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/836,665

(22) Filed: Jul. 15, 2010

Related U.S. Application Data
(63) Continuation of application No. 11/134,601, filed on May 20, 2005.

(51) Int. Cl. G06F 9/44; G06F 15/16

(52) U.S. Cl. 717/110; 709/217

(57) ABSTRACT

A method of creating an XML based framework to perform automated forecasting includes sending a file from a local host computer to a remote computer, receiving a file at the local host computer from the remote computer, installing the received file on the local host computer, and executing commands on the local host computer and the remote computer. Executing a command on the remote computer includes reading a run file and a host definition file. A framework for interacting between the local host computer and the remote computer is determined based on types of XML tags, the XML tags including at least one of a start of a tag, end of a tag, and text between the start of a tag and the end of a tag. Computer program products for creating an XML based framework to perform automated forecasting are also described.

### CROSS REFERENCE TO RELATED APPLICATIONS

This application is a continuation application of U.S. patent application Ser. No. 11,134,601, filed on May 20, 2005, the entire disclosure of which is incorporated by reference herein.

### TECHNICAL FIELD

Aspects of the invention generally relate XML-based scripting framework, and methods of providing automated interactions with remote host systems.

### BACKGROUND OF THE INVENTION

Establishing automated forecasting systems can be difficult. Engineers intending to set-up such automated forecasting systems had to be more concerned about the mechanics of sending, receiving, and executing files than the specifications of their dynamic models. Existing approaches are cumbersome to create custom scripts in a generic way so as to facilitate simple reuse of existing scripts prepared for other model applications.

Moreover, utilization of remote machines for the purpose of running model simulations poses additional challenges with respect to sending files to the remote locations, running scripts on remote systems, and retrieving files from the remote locations. Due to the challenges posed by interacting with remote machines, most model forecasting applications were set up to run on a limited number of locally available computer systems, and often on a single local computer system.

Common tools that were used include shell scripts (e.g., Bourne, C-shell, etc.) that interacted with various file transfer utilities include, for example, ftp, rcp, and scp. Using such tools and methods of automating a forecast system are not only inefficient as most scripts cannot be reused, but they also limit computing resources by making the interaction with remote machines extremely cumbersome and non-intuitive. Moreover, the resulting model run script could not be easily reused even for slightly differing scenarios with respect to either hardware (e.g. computer system) or software (e.g., applications). Additionally, such scripts would not fit into a forecasting environment when a higher level of automation is desired.

Accordingly, there is a need to overcome the above-identified problems.

### SUMMARY OF THE INVENTION

In some embodiments, a method of creating an XML based framework to perform automated forecasting includes sending a file from a local host computer to a remote computer, getting a file at the local host computer from the remote computer, copying the received file on the local host computer, and executing commands on the local host computer and the remote computer. Executing a command on the remote computer includes reading a run file and a host definition file. A framework for interacting between the local host computer and the remote computer is determined based on types of XML tags, the XML tags including at least one of a start of a tag, end of a tag, and text between the start of a tag and the end of a tag.

In other embodiments, a method of creating an XML based framework includes sending a file from a first computer to a second computer, getting a file from the second computer, saving the received file on the first computer, and executing commands on the first and second computers, wherein a framework for interacting between the first and second computers is determined based on types of XML tags, the XML tags including at least one of a start of a tag, end of a tag, and text between the start of a tag and the end of a tag.

### BRIEF DESCRIPTION OF THE DRAWINGS

Preferred embodiments of the invention are described below with reference to the following accompanying drawings.

FIG. 1 is a high level block diagram of an exemplary forecasting system in accordance with various embodiments of the invention.

FIG. 2 shows a logical flow of an XML-based scripting network (e.g., securerun) as it processes a run file.

FIG. 3 is a sample run file that use the <putfile>, <pfile/>, and <script> tags.

FIG. 4 illustrates a run file that utilizes the macros identified in Table 2, the macros being defined at run time.

FIG. 5 illustrates a high-level schematic of an application of XML based scripting framework wherein arrows represent either file transfers or remote commands.

FIG. 6 illustrates a methodology involved in an exemplary model forecasting system using a preferred embodiment of the invention, the model forecasting system seeking remote host interaction automation.

FIG. 7 shows an exemplary host definition file.

FIG. 8 shows details of the local host computer shown in FIG. 1.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

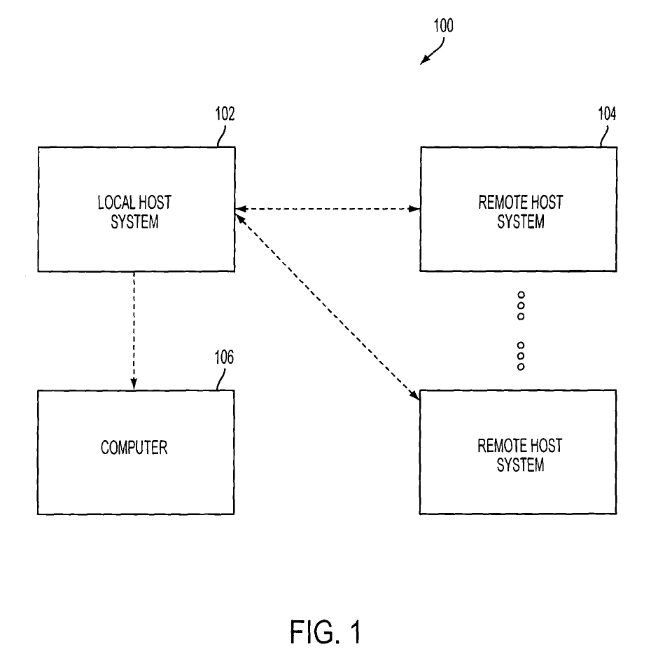

FIG. 1 is a high level block diagram of an exemplary forecasting system 100 in accordance with various embodiments of the invention. The forecasting system 100 includes a local host system 102, a remote host system 104, and a computer system 106 located remote from but in communication with the local host system 102 and the remote host system 104. A plurality of remote host systems can be used. The computer system 106 is configured to store information sent from either the local host system 102 or the remote host system 104. The local host system 102 and the computer system 106 are designed to function in an identical fashion. In a preferred embodiment of the invention, all actions originate from the local host system 102. For example, in order to obtain a file from the remote host system 104, a XML based framework (e.g., securerun) in accordance with various aspects of the invention is configured to connect to the remote host system 104 and request a file transfer through a secure remote connection tool (e.g., Secure Shell (ssh)). The XML based framework in accordance with various aspects of the invention is also referred to herein as “securerun.”

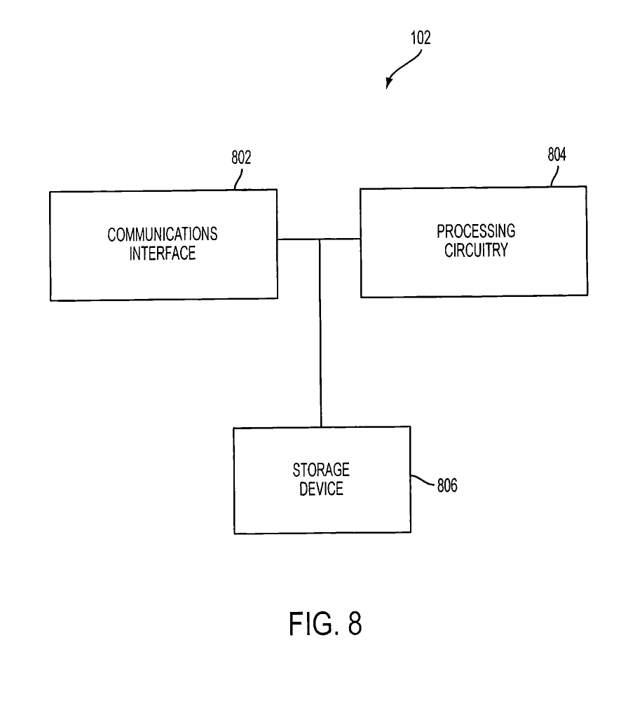

In another embodiment of the invention, securerun also has the ability to use a less secure, remote shell (rsh) application. It will be appreciated that other interfaces can be added for various other file transfer and remote shell applications to securerun. Such various other applications can include, for example, ftp, rsync, or ktelnet. Further details of the local host system 102 will be described with respect to FIG. 8.

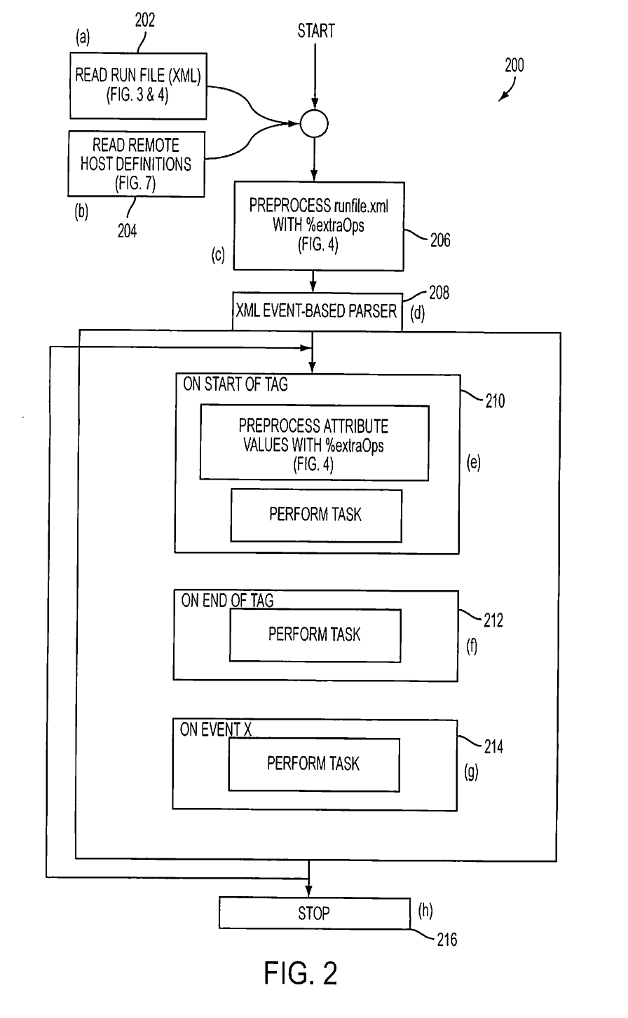

FIG. 2 shows a logical flow 200 of an XML-based scripting framework (e.g., securerun) as it processes a run file. As noted above, securerun is defined herein as an XML-based scripting application configured to be executed on a computer system such as, for example, local host system 102. By maintaining control at the local host system 102, securerun ensures that a user has maximum control over the actions, thereby minimizing the user's reliance on the remote host system 104 (e.g., remote hosting environment). The logical flow 200 can be performed in the local host system 102. At steps 202 and 204, a run file and a host definition file, respectively, are read by securerun residing in the local host system 102. The host definition file, for example, defines interpretors available for use with the run file (e.g., <runfile>) and <script> tags. After the runfile and the host definition file are read as in steps 202 and 204, the process flow now moves to step 206.

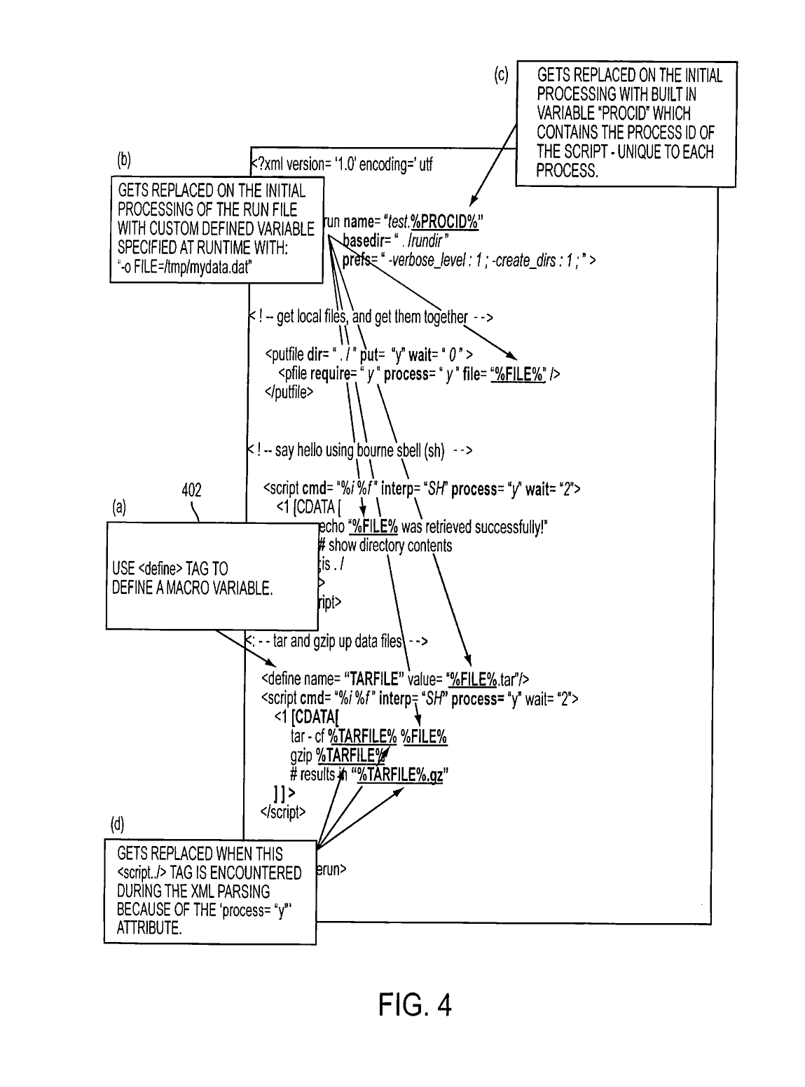

At a step 206, the runfile (e.g., runfile.xml) is preprocessed to substitute any predefined variables. Some examples of the variables included in an unaltered run file are shown in FIG. 4. The process then proceeds to step 208.

At a step 208, the preprocessed run file is parsed and securerun follows the directions that are included within the run file tags. A processing circuitry (e.g., processing circuitry 804 shown in FIG. 8), of the local host system 102, can be configured to perform various functions that are executable by the securerun application/framework. A parser that can be stored in the local host system 102 (FIG. 1) can be designed such that it can detect and act based on different XML “events” such as, for example, the start of a tag, the end of a tag, or text between tags. It will be appreciated that the parser can also be a part of the processing circuitry 804. Such ability enables securerun to choose a course of action based on the type of “event”. Exemplary events that can be detected include:

Start of a tag—the processing circuitry (e.g., processing circuitry 804 of FIG. 8) is configured to determine the identity of a tag, and calls a function that is specific for the start of such a tag whose identity is determined. Such a task is performed at step 210.

End of a tag—the processing circuitry (e.g., processing circuitry 804) is configured to determine the identity of a tag, and calls a function that is specific for the end of such a tag whose identify is determined. Such a task is performed at step 212. The method now moves to step 214.

At a step 214, the processing circuitry (e.g., processing circuitry 804) is configured to process other XML events such as, for example, text between tags such as, for example, between an opening and closing <script> tag.

Step 208 illustrates a generalized view of an event-based XML parsing. When events outlined above with respect to steps 210, 212, and 214 are detected, specific functions are called by securerun to handle such events. The process loops back to step 210 if further events requiring processing as described above with respect to steps 210-214 are identified. Once the end of the run file has been reached, designated by the <securerun> tag, securerun exits out of the XML processing routine, and ends the execution as identified at step 216.

Macro Processing

Securerun includes a macroprocessing routine that enables users to build templates using macros, or variables, that are defined at run time. Macro processing is a search and replace function that searches for macros within the run file or external text files, and replaces such files with their respectively defined values if they are defined by one of securerun's macro definition methods that include:

using the “-o” flag when securerun is executed;

using the <define> tag in the run file;

capturing output from the <script> or <runfile/> tags.

Users can leverage securerun so that by simply defining a variable can alter the functionality of the application. Various built-in variables can be set at the start of an application. The built-in variables are shown in Table 1 below:

TABLE I

| Name | Value | Description |
|---|---|---|
| % PROCID % | The process id of the current | This number is assigned by the operating |
| | instance of Securerun. | system whenever Securerun is started. |
| % UNIQUE % | This macro provides a unique string | No two % unique % macros will be replaced |
| | each time it is encountered. | with the same value, even within the same |
| | | process. |
| % BASEDIR % | The base or “home” directory set | Allows for the reference of the current base |
| | within the opening <securerun> tag | directory without having to explicitly set it |
| | or changed by the <chbasedir/> | with the <define/> tag. |
| | tags. | |
| % TMPDIR % | The temp directory used by | Allows for the reference of the temp |
| | Securerun set within the opening | directory without having to explicitly set it |
| | <securerun> tag. | with the <define/> tag. |
| % STDOUT % | Contains the standard output of the | Captures the output of the last action |
| | last <runfile/> or <script> tag that | invoked by the <runfile/> or <script> tags so |
| | was run unless the “name” attribute | that it doesn't have to be explicitly captured |
| | was specified with either tag. | with the “name” attribute. |

Also included in the securerun are a user's environmental variables of a local machine (e.g., local host system 102). Such allows for default variables set in the user's local environment to be included in the secururun, thereby eliminating the need for the user to be aware of definitions of the default variables. The user can, however, override the default values by using a <define/> tag in the run file and assigning a new value to the variable.

Applications written within the securerun framework prefer a file (e.g., run file) that integrates (e.g., ties) distinct pieces of the application. Such distinct pieces of information could be commands, actions, scripts, standalone executables, etc. The file that integrates all the distinct pieces of the application is referred to herein as a “run file”. In a preferred embodiment, the run file is a text file (as opposed to binary) that is written using XML compliant tags configured to direct securerun's execution. The run file uses a set of tags that are specific for securerun, described below at Table 2.

TABLE 2

| Tag | Description |
|---|---|
| <securerun> | Root tag - this means that all other tags must be |
| . . . | contained within an opening <securerun> and closing |
| </securerun> | </securerun> tag. Attributes include “name”, “basedir”, |
| | and “prefs”. |
| | Example: |
| | <securerun name=”test” basedir=”.” prefs=”- |
| | create_dirs:1;”> |
| | (all other tags here . . . ) |
| | </securerun> |
| <pfile/> | This tag is used to put files onto remote hosts, get files |
| | from remote hosts, or copy a local file to another local |
| | directory. |
| <putfile> | This tag allows multiple files to be transferred to one |
| . . . | location by enclosing a series of <pfile/> tags between the |
| </putfile> | opening and closing <putfile> tags. |
| <runfile/> | This tags is used to execute the specified file using the |
| | specified external program specified by the “interp” |
| | attribute. |
| <script> | This tag allows the embedding of any kind of text inside of |
| . . . | the run file. The embedded text is most commonly some |
| </script> | type of programming language meant to be read and |
| | executed by some external interpretor. |
| <define/> | This tag defines a macro variable which is then available |
| | for use by the macro processing feature. |
| <undefine/> | This tag removes a macro variable of the specified name |
| | if it exists. |
| <chbasedir/> | This tag changes the local base directory from which |
| | Securerun is executing during run time. |
| <input/> | This tag incorporates interactivity into a Securerun |
| | application by printing the specified message to the |
| | screen, and waits for a keyboard response by the user. |
| | The user input is then saved as a macro variable of the |
| | specified name. |
| <output/> | This tag simply prints a specific message to the screen. |

Since the XML standard is platform neutral and self-descriptive, such format is preferred to design the run file. Further, since XML is self descriptive, all the relevant data can be extracted using a generic parser.

Securerun uses the XML run file to describe the steps (e.g., an ordered list of actions) that an application is desired to undertake. As described above in Table 2, each XML run file includes a series of securerun specific XML tags that are used to specify an action for securerun to perform. A run file is preferred to start with <securerun> tag and end with its closing tag, </securerun>. Other tags, if they are used, can be listed within the <securerun> . . . </securerun> tags. Tags that do not follow such a format may be ignored.

The tags that serve most directly to implement preferred features (e.g., transfer and execution of files) of securerun include <pfile/>, <putfile>, <runfile/>, and <script>. The <pfile> tag indicates to securerun to move a specified file to a specified location (e.g., any combination of remote or local locations) and can be used with <putfile> to transfer multiple files to a similar location. The <runfile/> tag indicates to securerun to execute a specified file in a specified location (e.g., local or remote or combination thereof). The <script> tag is a hybrid of <pfile/> and <runfile/> that allows a user to define the actual content of a text file during runtime that can be transferred to and executed on a specified host, such as, for example, on a local host system 102. Other systems such as, for example, computer system 106 can also be specified.

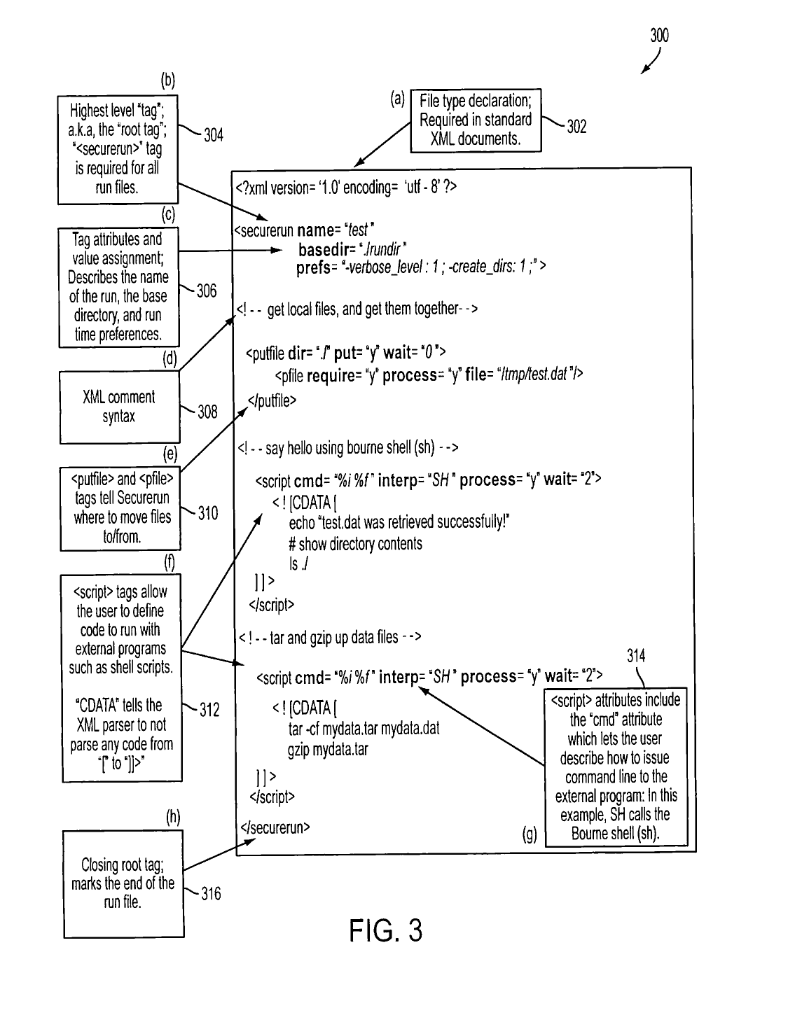

FIG. 3 is a sample run file that uses the <putfile>, <pfile/>, and <script> tags. The first line of the run file, as indicated by reference numeral 302, declares that the run file is an XML file. The first line can be required by most generic parsers in order for the XML file to be considered valid. The opening tag <securerun> and the closing tag </securerun> are indicated by reference numerals 304 and 316, respectively. As described above, all other tags of the run file are preferred to be present between the <securerun> opening tag and the </securerun> closing tag. The opening <securerun> tag also includes attributes that are used to set a name for the run file, designate a base directory (e.g., ‘basedir’) on a local host system (e.g., local host system 102) where securerun is executed, and specifies exemplary run time settings (e.g., ‘prefs’) that are used by securerun. An XML comment is distinguished in text box 308, in which the text included between the comment notation “<- -” and “- ->” is preferably ignored by the processing circuitry (e.g., processing circuitry 804 shown in FIG. 8) configured to execute the securerun application.

The use of the <pfile/> and <putfile> tags are used for copying files from one location to another as indicated by reference numeral 310. For example, files can be copied from local host system 102 to computer system 106. The <pfile> tag also has the ability to be used as a standalone tag, or it can be used in a batch mode that transfers multiple files at once. The <putfile> tag specifies the target location in the “dir” attribute for all of the files that <pfile> specifies with its “file” attribute and such files are copied to a specified location such as, for example, computer system 106.

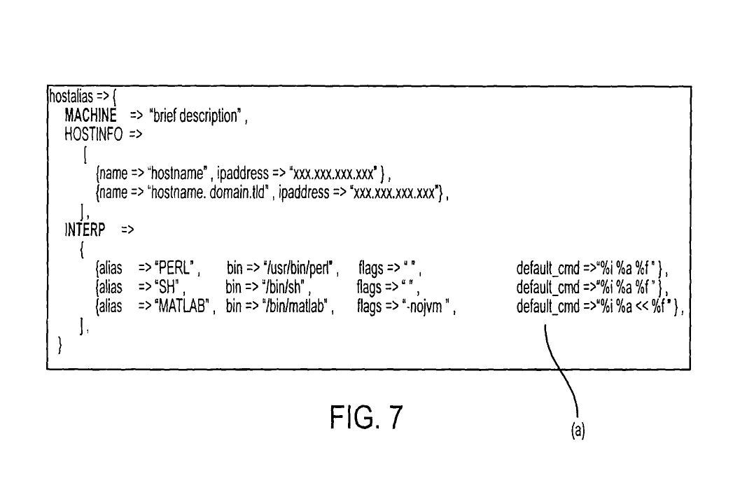

The <script> tag, identified by reference numeral 312, is used to embed text of any kind into the run file. The intended use of the <script> tag is to provide a way to specify and execute arbitrary programs/scripts under such exemplary interpretors as system shells (e.g., Bourne, C-Shell, etc.), scripting languages (e.g., Perl, Python, Ruby, Matlab, etc.), and compile languages (e.g., FORTRAN, C, C++, Java). For example, the <script> tags illustrated in FIG. 3 include Bourne shell scripts that are run by a shell interpretor external to securerun. The attribute “interp” shown in FIG. 3 is used to specify an interpretor that should be used. Valid interpretors are defined for each host in the host definition file, as shown, for example, in FIG. 7.

Continuing to refer to FIG. 3, the <script> tag includes an attribute called “cmd”, as indicated by reference numeral 314 that enables a user to define a command format used to execute the file containing the text within the <script> tag. By using “% i” (interpretor), “% f” (file), and “% a” one can control how a command is issued to any interpretor that accepts command line arguments. Such a feature is also available to the <runfile/> tag. Table 3 illustrates the various formatting rules:

TABLE 3

| Formatting Variable | Description |
|---|---|
| % i | In the external interpretor call, it is replaced by the |
| | interpretor specified with the “interp” attribute. |
| % f | Represents the file specified in the “file” attribute. |
| % a | Represents the values supplied in the “arg” attribute. |

The ability to control the command format when calling external programs is desired for using applications such as, for example, Matlab that do not follow the conventional way of running a script at the command line. Default command formats are set in the host definition file shown in FIG. 7. The remainder of the tags shown in Table 2 can be used to provide further flexibility to securerun.

FIG. 4 illustrates a run file that utilizes the macros identified in Table 2 and intended to be defined at run time. For example, <define/> macro as illustrated by reference numeral 402 adds a name/value pair for use by the processing circuitry (e.g., processing circuitry 804 shown in FIG. 8) configured to process the macro.

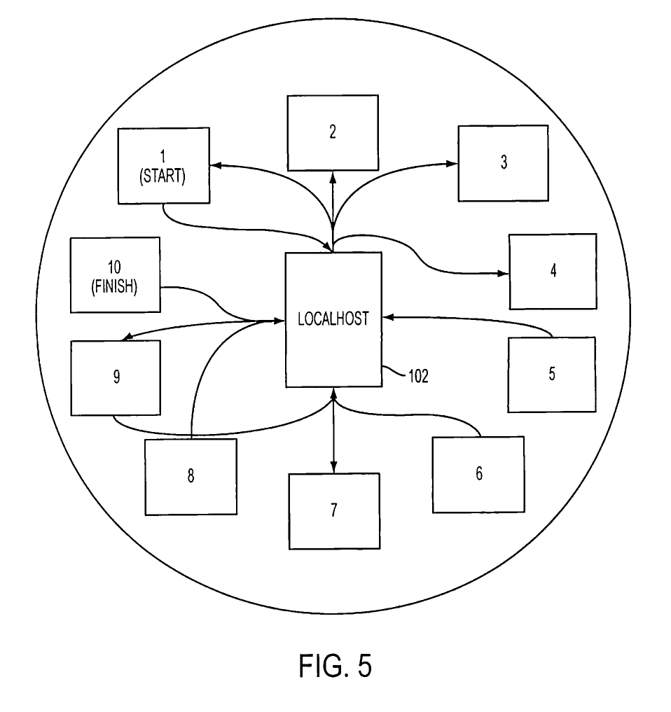

FIG. 5 illustrates a high-level schematic of an application of an XML based scripting framework wherein arrows represent either file transfers or remote commands. In a preferred embodiment, arrows pointing away from the local host system 102 can represent either commands or file transfers, but arrows pointing to the local host system 102 can only be file transfers. Securerun allows all actions to be initiated from the local host system 102. Reference numerals 1 through 10 of FIG. 5 represent a plurality of remote hosts and depict the order in which each remote host is utilized in an exemplary scenario. One of the remote hosts shown in FIG. 5 can be the remote host 104 shown in FIG. 1.

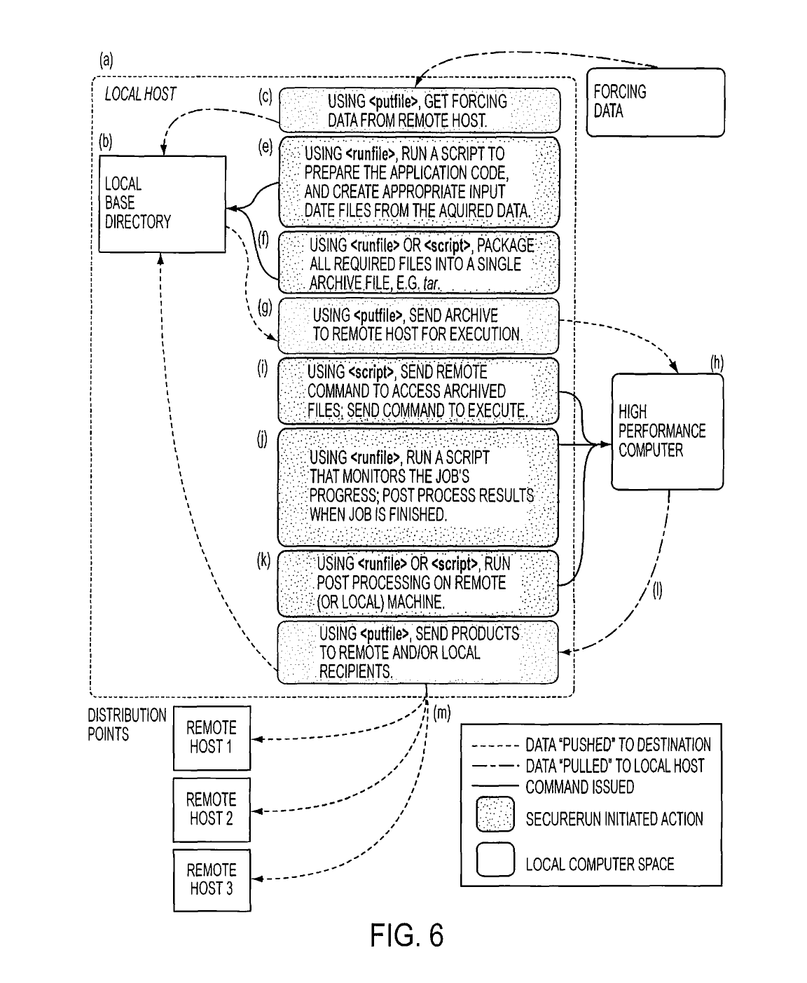

FIG. 6 illustrates a methodology involved in an exemplary model forecasting system (e.g., an oceanographic or atmospheric forecasting system that has as an input meteorological forcing data) using a preferred embodiment of the invention, the model forecasting system seeking remote host interaction automation. The forecast system functionality includes the following steps:

At steps (a), (b), and (c), the method obtains and processes input from remote sources.

At a step (e), a script is run to prepare the application code and also to create input data files from the acquired data.

At a step (g), the application code is forwarded to be processed by a computer system, such as, for example, computer system 106.

At steps (h) and (i), the application code is run.

At steps (j) and (k), post processing of the application code is performed and the results are obtained.

At steps (l) and (m), the obtained results are distributed.

In some cases, the computer system on which the application (e.g., securerun) is configured and prepared is not the same computer system that executes the application code. In such cases, there would be a need for simulations prepared on one computer system to be archived (e.g., using an application like tar) and sent to the computer system performing the computations. Once the archived files are on the remote host, such files need to be unarchived prior to initiating the application. Securerun would be able to accomplish the above tasks with relative ease. Once the application code is produced, securerun can retrieve output files for post processing on a local host system (e.g., system 102) or a remote machine (e.g., remote host 104). The processed results can be used to send deliverables (e.g., images, data sets, etc.) to the local host or predetermined remote hosts for distributing results via anonymous ftp, World Wide Web, etc.

FIG. 8 shows details of the local host computer 102 shown in FIG. 1. For example, securerun application can be installed and configured for execution on the local host system 102. The illustrated local host system 102 includes a communications interface 802, processing circuitry 804, and a storage device 806.

Communications interface 802 is configured to communicate electronic data externally of the computer 102, for example, with respect to the remote host system 104, computer system 106, and other external devices. Interface 802 may comprise a parallel port, USB port, EIO slot, network interface card, IEEE 1394 connector, and/or other appropriate configuration capable of communicating electronic data.

Processing circuitry 804 is configured to process data received from the remote host 104. Processing circuitry 804 is further configured to control all the functions of the local host system 102. In one embodiment, processing circuitry 804 may comprise circuitry configured to execute provided programming. In one example, processing circuitry 804 may be configured to include executable applications. For example, processing circuitry 804 may be implemented as a microprocessor or other structure configured to execute executable applications of programming including, for example, software and/or firmware instructions. Other exemplary embodiments of processing circuitry 804 include hardware logic, PGA, FPGA, ASIC, and/or other structures. These examples of processing circuitry 804 are for illustration and other configurations are possible for implementing operations discussed herein.

Storage device 806 is configured to store electronic data, a database with file systems having one or more electronic files, programming such as executable instructions (e.g., software and/or firmware), and/or other digital information and may include processor-usable media. Processor-usable media includes any article of manufacture that can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, and infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

As illustrated in the depicted example, storage device 806 is configured to store file systems having one or more electronic files with information related to the securerun application.

Aspects of the invention provide various advantages, which in some embodiments include efficient and easy creation of an automated forecasting system. It will be appreciated that securerun is not limited to creating forecasting system, but can be used to create any type of application that exhibits a need for automated interaction with remote hosts.

By using a limited set of primitive instructions, one can put together a complex system that leverages both local and remote computer systems. These instructions include sending a file from a local host to a remote host, obtaining a file from the remote host and saving the obtained file on the local host, copying a file from the local host to another second location, executing a command on the remote host, and executing a command on the local host.

Securerun enables a user (e.g., applications developer) to leverage the power of multiple computers without having to be overly concerned about the nuances of transferring files and executing remote commands. The user can treat the remote machines as available resources that can be used as easily as a local host computer system. Such would be beneficial in designing and creating an automated and distributed system.

A feature of the securerun that makes the framework flexible is its ability to perform macro-processing operations as described above. By using the macros in conjunction with external files, generic scripting templates can be created. Such templates can be processed at run time to create scripts that can be customized for a task. This framework would be beneficial as there would be no need to maintain a library of differing scripts. The tags that handle files include an attribute called “process” which can be set to a “YES” or “NO” to indicate to securerun whether or not to process the file by replacing any defined macro variables with their current values. The “process” attribute is available at least for <pfile/>, <runfile/>, and <script> tags.

Using the securerun framework, any script or binary executable on a local host system or a remote host system can be used to put together an application. Securerun can be used to create a framework to connect system commands, scripts, and files together in order to form an application that can be configured to run automatically. Securerun can interface with various command utilities through the flexibility provided for using the “cmd” attribute in the <script> and <runfile/> tags.

Securerun can also provide user interactivity by providing an easy way to prompt users for input using, for example, the <input/> tag. When such a tag is encountered, securerun displays messages defined using the “msg” attribute and assigns information input by the user to a macro variable specified using a “name” attribute. If desired, this feature can be turned off with a command line flag set when executing the securerun framework.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of creating an XML based framework, comprising:
sending a file from a first computer to a second computer;
receiving a file from the second computer;
copying the received file on the first computer; and
executing commands on the first and second computers, wherein a framework for interacting between the first and second computers is determined based on XML tags, the XML tags including at least one of a start of a tag, end of a tag, and text between the start of a tag and the end of a tag.

2. The method of claim 1, wherein the first computer is a local host computer and the second computer is a remote host computer.

3. The method of claim 1, wherein actions for creating the XML framework are initiated by the first computer.

4. The method of claim 1, wherein executing the command on the second computer includes reading a run file and a host definition file.

5. The method of claim 4, wherein the host definition file defines interpretors for use with the run file and a script tag, the script tag being used to embed text into the run file.

6. The method of claim 5, wherein the script tag is configured to specify and execute arbitrary scripts under at least system shells or compiled languages.

7. The method of claim 6, wherein a pre-processed run file is parsed using directions included in the run file, and the arbitrary scripts can be modified to fit within the XML based framework.

8. The method of claim 1, wherein when the XML tags are detected, specific functions are called to handle the detected tags.

9. The method of claim 1, wherein the framework is platform independent and self descriptive, and further wherein data is extracted using a generic parser.

10. The method of claim 1, wherein an XML run file describes an ordered list of actions for the framework to execute.

11. The method of claim 11, when the XML run file starts with the start of a tag and ends with the end of a tag.

12. The method of claim 11, wherein the XML run file includes attributes configured to perform one or more of establishing a name for an application, designating a base directory on the first computer, and specifying run time settings.

13. The method of claim 1, wherein the XML based framework is configured to support macroprocessing for enabling user to build templates using macros, the macros being defined at run time.

14. The method of claim 13, wherein the macros are replaced with values defined by macro definition methods.

15. The method claim 14, wherein the defined values include user's environment variables of a local computer, thereby eliminating a need for the user to be aware of variable definitions.

16. A method of creating an XML based framework to perform automated forecasting, comprising:
sending a file from a local host computer to a remote computer;
receiving a file at the local host computer from the remote computer;
saving the received file on the local host computer; and
executing commands on the local host computer and the remote computer, wherein executing a command on the remote computer includes reading a run file and a host definition file, and further wherein a framework for interacting between the local host computer and the remote computer is determined based on XML tags, the XML tags including at least one of a start of a tag, end of a tag, and text between the start of a tag and the end of a tag.

17. The method of claim 16, wherein the host definition file defines interpretors for use with the run file and a script tag, the script tag being used to embed text into the run file.

18. The method of claim 17, wherein the run file includes attributes configured to perform one or more of establishing a name for an application, designating a base directory on the local host computer, and specifying run time settings.

19. The method of claim 17, wherein the XML based framework is configured to support macroprocessing for enabling user to build templates using macros, the macros being defined at run time.

20. The method of claim 19, wherein the macros are replaced with values defined by macro definition methods.

21. The method claim 20, wherein the defined values include user's environment variables of a local computer, thereby eliminating a need for the user to be aware of variable definitions.

22. A computer program product including computer readable memory to execute programming, the computer program product comprising:
means for sending a file from a local host computer to a remote computer;
means for receiving a file at the local host computer from the remote computer;
means for saving the received file on the local host computer; and
means for executing commands on the local host computer and the remote computer, wherein executing a command on the remote computer includes reading a run file and a host definition file, and further wherein a framework for interacting between the local host computer and the remote computer is determined based on types of XML tags, the XML tags including at least one of a start of a tag, end of a tag, and text between the start of a tag and the end of a tag.

23. The computer program product as in claim 22, wherein the host definition file defines interpretors for use with the run file and a script tag, the script tag being used to embed text into the run file.

24. The computer program product of claim 23, wherein the run file includes attributes configured to perform one or more of establishing a name for an application, designating a base directory on the local host computer, and specifying run time settings.

25. The computer program product of claim 24, wherein the XML based framework is configured to support macroprocessing for enabling user to build templates using macros, the macros being defined at run time.
